(19) United States
(12) Patent Application Publication
(10) Pub. No.: US 2005/0039049 A1
(43) Pub. Date: Feb. 17, 2005

(54) Method and apparatus for a multiple concurrent writer file system

(75) Inventors: Joon Chang, Austin, TX (US); Gerald Francis McBrearty, Austin, TX (US); Duyen M. Tong, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/640,848

(22) Filed: Aug. 14, 2003

(51) Int. Cl. G06F 12/00

(52) U.S. Cl. 713/201

(57) ABSTRACT

A method and apparatus for a multiple concurrent writer file system are provided. With the method and apparatus, the metadata of a file includes a read lock, a write lock and a concurrent writer flag. If the concurrent writer flag is set, the file allows for multiple writers. That is, multiple processes may write to the same block of data within the file at approximately the same time as long as they are not changing the allocation of the block of data, i.e. either allocating the block, deallocating the block of data, or changing the size of the block of data. Multiple writers is facilitated by allowing processes performing write operations that do not require or result in a change to the allocation of data blocks in a file to use the read lock of a file rather than the write lock of the file. Software serialization or integrity mechanisms may be used to govern the manner by which these concurrent write operations have their results reflected in the file structure. Those processes performing write operations that do require or result in a change in the allocation of data blocks in a file must still acquire the write lock before performing their operation.

### BACKGROUND OF THE INVENTION

1. Technical Field

The present invention is generally directed to an improved file system for a data processing system. More specifically, the present invention is directed to a local file system that permits multiple concurrent readers and writers.

2. Description of Related Art

A file system is a computer program that allows other application programs to store and retrieve data on media such as disk drives. A file is a named collection of related information that is recorded on a storage medium, e.g., a magnetic disk. The file system allows application programs to create files, give them names, store (or write) data into them, to read data from them, delete them, and perform other operations on them. In general, a file structure is the organization of data on the disk drives. In addition to the file data itself, the file structure contains metadata: a directory that maps file names to the corresponding files, file metadata that contains information about the file, most importantly the location of the file data on the disk (i.e. which disk blocks hold the file data), an allocation map that records which disk blocks are currently in use to store metadata and file data, and a superblock that contains overall information about the file structure (e.g., the locations of the directory, allocation map, and other metadata structures).

File systems may be localized, such as a file system for a particular computing device, or distributed such that a plurality of computing devices have access to shared storage, e.g., a shared disk file system. In both cases, it is important to ensure the integrity of the file structure accessed by the file system so that corruption of data is not permitted. This is typically performed by governing the computing devices and/or applications that may read or write to the files of the file structure.

Consider a file structure stored on N disks, D0, D1, . . . , DN−1. Each disk block in the file structure is identified by a pair (i,j), e.g., (5, 254) identifies the 254^{th} block on disk D5. The allocation map is typically stored in an array A, where the value of element A(i,j) denotes the allocation state (allocated/free) of disk block (i,j).

The allocation map is typically stored on disk as part of the file structure, residing in one or more disk blocks. Conventionally, A(i,j) is the kth sequential element in the map, where k=iM+j, and M is some constant greater than the largest block number on any disk.

To find a free block of disk space, the file system reads a block of A into a memory buffer and searches the buffer to find an element (A(i,j) whose value indicates that the corresponding block (i,j) is free. Before using block (i,j), the file system updates the value of A(i,j) in the buffer to indicate that the state of the block (i,j) is allocated, and writes the buffer back to disk. To free a block (i,j) that is no long needed, the file system reads the block containing A(i,j) into a buffer, updates the value of A(i,j) to denote that block (i,j) is free, and writes the block from the buffer back to disk.

If the nodes comprising a shared disk file system, or a plurality of applications on a single computing device, do not properly synchronize their access to the shared storage, they may corrupt the file structure. This applies in particular to the allocation map. To illustrate this, consider the process of allocating a free block described above. Suppose two nodes simultaneously attempt to allocate a block. In the process of doing this, they could both read the same allocation map block, both find the same element A(i,j) describing free block (i,j), both update A(i,j) to show block (i,j) as allocated, both write the block back to disk, and both proceed to use block (i,j) for different purposes, thus violating the integrity of the file structure.

A more subtle but just as serious problem occurs even if the nodes simultaneously allocate different blocks X and Y, if A(X) and A(Y) are both contained in the same map block. In this case, the first node sets A(X) to allocated, the second node sets A(Y) to allocated, and both simultaneously write their buffered copies of the map block to disk. Depending on which write is done first, either block X or Y will appear free in the map on the disk. If, for example, the second node's write is executed after the first node's write, block X will be free in the map on disk. The first node will proceed to use block X (e.g., to store a data block on a file), but at some time later another node could allocate block X for some other purpose, again with the result of violating the integrity of the file structure.

In order to ensure the integrity of the file structure, many file systems make use of an integrity manager or concurrency management mechanism that determines how to govern reads and writes to the storage device. The most widely used mechanism is a locking mechanism in which processes must obtain a lock on a block of data in order to access the block of data. For example, a block of data may have a read lock and a write lock. Any number of processes may obtain the read lock concurrently and thus, be able to read the data in the block at approximately the same time. However, only one process may obtain the write lock at any one time. Thus, multiple concurrent readers are possible but only one writer is permitted at any one time. This ensures that two or more processes cannot write to the same block of data at the same time, such as in the situation previously discussed.

Some computer applications also provide for their own serialization or locking of blocks of data. For example, databases typically include integrity management mechanisms for ensuring that the integrity of the records within the database is maintained. These application based integrity management mechanisms manage reads and writes to records of the database so that the database is not corrupted.

An example of such an integrity management mechanism is the two-phase commit. In the two-phase commit, a prepare phase is followed by a commit phase. In the prepare phase, a global coordinator (initiating database) requests that all participants (distributed databases) agree to commit or rollback a transaction. In the subsequent commit phase, all participants respond to the coordinator that they are prepared and then the coordinator requests all nodes to commit the transaction. If all participants cannot prepare or there is a system component failure, the coordinator asks all databases to rollback the transaction.

In situations where an application, such as a database, provides for its own serialization or locking, there is no need for the file system to limit the number of concurrent writers to a single writer in order to avoid corruption of the file structure. In fact, in some situations, the potential speed at which the application may execute is impaired by the limitations of the file system. Thus, it would be beneficial to remove the limitations of the file system with regard to concurrent writers when the file in question is associated with an application having its own serialization or locking mechanisms.

### SUMMARY OF THE INVENTION

The present invention provides a method and apparatus for a multiple concurrent reader/writer file system. With the method and apparatus of the present invention, the metadata of a file includes a read lock, a write lock, and a concurrent writer flag. If the concurrent writer flag is set, the file allows for multiple writers. In other words, multiple processes may write to the same block of data within the file at approximately the same time as long as they are not changing the allocation of the block of data, i.e. either allocating the block, deallocating the block of data, or changing the size of the block of data.

With the method and apparatus of the present invention, when an access request, e.g., a write or a read operation, is received for one or more data blocks of a file, a determination is first made as to whether the access request is a read request. If the access request is a read request, the reader lock of the file is obtained by the process sending the access request. Any number of processes may acquire the reader lock of a file at approximately the same time such that multiple concurrent readers are allowed.

If the access request is not a read access request, then the access request is determined to be a write access request. A determination is made as to whether the file permits multiple concurrent writers by determining the value of the concurrent writer flag in the metadata for the file. If the concurrent writer flag is set, then the file permits multiple concurrent writers. If the concurrent writer flag is not set, then the file does not permit multiple concurrent writers. If it is determined that multiple concurrent writers is not permitted, i.e. the concurrent writers flag is not set, then the process must obtain the writer lock to gain access to the file. Only one process may acquire the write lock at a time and thus, any subsequent process requesting write access to the file and needing to obtain the write lock will spin on the lock until it is released by the process that currently has acquired it. This also prevents readers from accessing the file. Thus, while there is a reader lock writers will spin on the lock and while there is a writer lock readers will spin on the lock.

If the file permits concurrent writers, i.e. the concurrent writer flag is set, then a determination is made as to whether the write access request is a write access request that intends to change the allocation of one or more blocks of the file. That is, if the write access request will result in a change in the size of the file either by allocating new data blocks to the file, deallocating existing blocks in the file, or changing the size of the existing blocks. If the write access request is one that will require or result in a change to the allocation of the data blocks of the file, then the write lock must be acquired by this process.

One situation in which a write access request will change the allocation of the data blocks of the file is when a file is extended, i.e. the request is a request to write to an offset that is greater than the current file size. Another situation where a write access request will change the allocation of the data blocks is when the file is truncated. Both of these situations require an update to the metadata structure associated with the file.

Another situation that results in a change to the metadata structure of the file is when an input/output request on the file violates the alignment or length restrictions of direct input/output. That is, the use of concurrent input/output preferably makes certain alignment and length restrictions that are to be adhered to by the application's I/O requests. By creating file systems with an appropriate block size, e.g., by specifying an aggregate block size equal to 512 kb at file system creation, such applications can benefit from the use of concurrent I/O without any modifications to the applications.

If the write access request does not require or result in a change in the allocation of data blocks of the file, then the process acquires a read lock of the file and performs its write operations using the read lock. It should be noted that the read lock does not prevent write operations from being performed on the file. Since multiple processes may acquire the read lock on the file at approximately the same time, there may be multiple concurrent readers and writers to the file at approximately the same time as long as the writers are not changing the allocation of the file.

Because the present invention is intended to be used in conjunction with applications that have their own serialization of changes to data blocks, e.g., a database application, the permitting of multiple writer processes does not degrade the integrity of the file structure. That is, the present invention removes the requirement that the file system ensure integrity by always permitting only one writer process at a time and allows the application to use its serialization mechanisms to govern how changes to blocks of data are to be committed. Only when actual changes to allocations are being made does the file system of the present invention limit changes to allocations to only one writer process at a time.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in accordance with the present invention;

FIG. 2 is an exemplary diagram of a server computing device in which the present invention may be implemented;

FIG. 3 is an exemplary diagram of a client computing device in which the present invention may be implemented;

FIG. 4A is an exemplary diagram illustrating the acquiring of locks with regard to a write access request that requires a change in allocation of data blocks for a file in accordance with the present invention;

FIG. 4B is an exemplary diagram illustrating the acquiring of locks with regard to a write access request that does not change the allocation of data blocks for a file in accordance with the present invention; and

FIG. 5 is a flowchart outlining an exemplary operation of the present invention.

### DETAILED DESCRIPTION OF THE PREFERRED EMBODIMENT

The present invention provides a method and apparatus for allowing multiple concurrent writer processes to the same file. The present invention may be implemented in a stand alone computing device or in a distributed data processing system. For example, the present invention may be implemented by a server computing device, a client computing device, a stand alone computing device, or a combination of a server computing device and a client computing device. Therefore, a brief description of a distributed data processing system and stand alone computing device are described hereafter in order to provide a context for the operations of the present invention described thereafter.

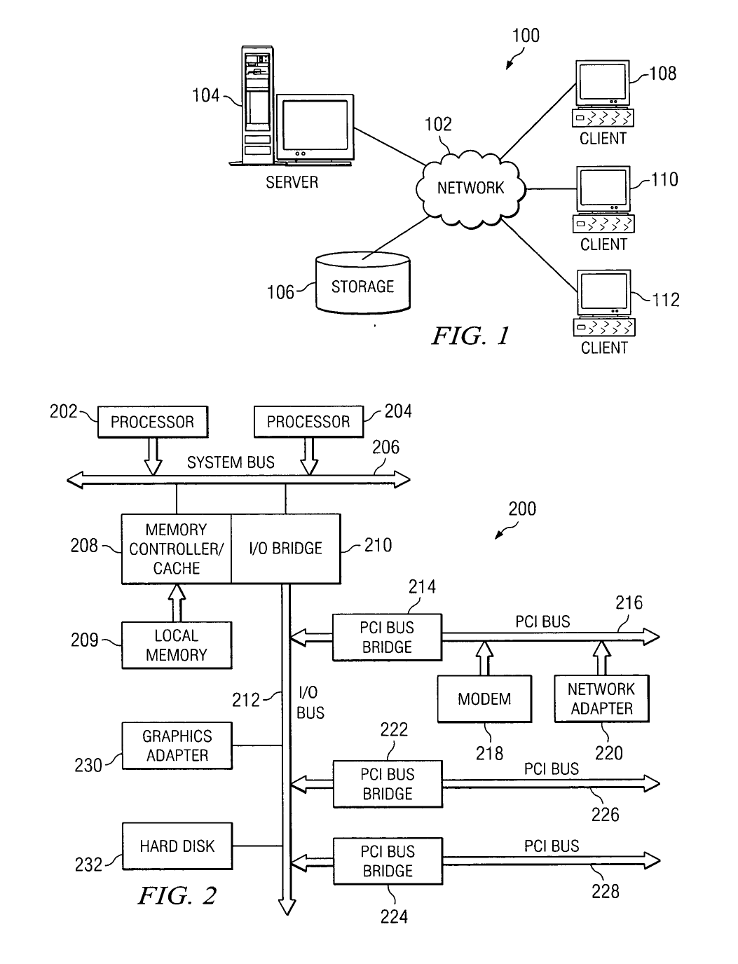

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

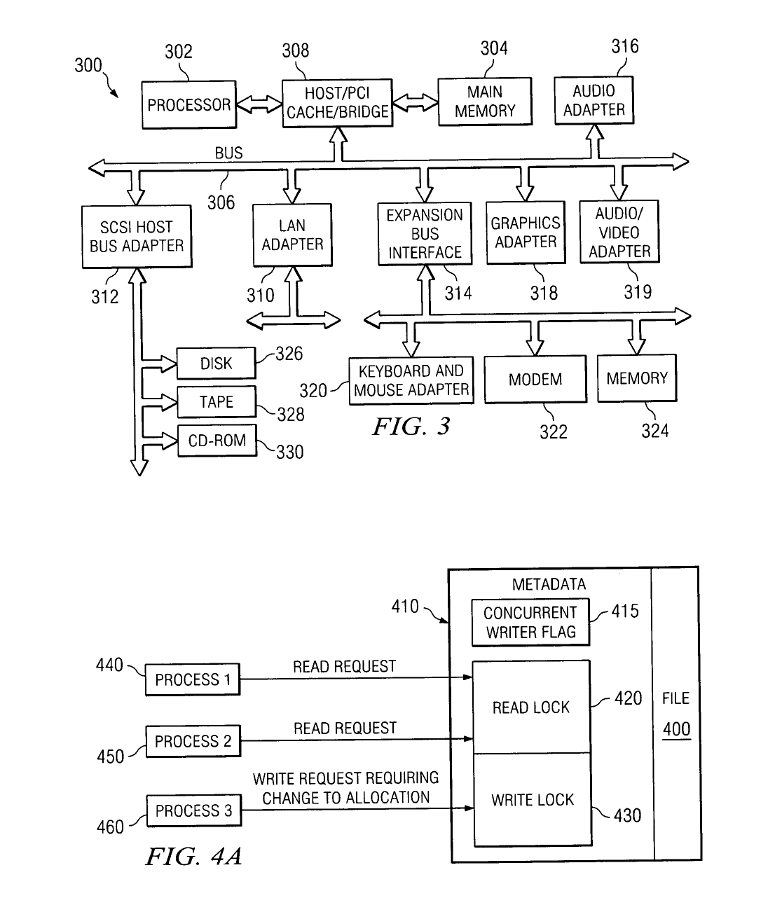

With reference now to FIG. 3, a block diagram illustrating a data processing system is depicted in which the present invention may be implemented. Data processing system 300 is an example of a client computer or a stand alone computing device. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As previously mentioned, the present invention provides a method and apparatus for allowing multiple concurrent writer processes to access the same file at approximately the same time. The present invention is preferably implemented in a computing system that employs an application that has its own serialization mechanisms for ensuring the integrity of changes to files. In a preferred embodiment, this application may be a database application such as Oracle and DB2. However, any database application that enforces their own serialization for accesses to shared files can use concurrent I/O, in accordance with the present invention, to reduce CPU consumption and eliminate the overhead of copying data twice, i.e. first between the disk and the file buffer cache, and then from the file buffer cache to the application's buffer.

The present invention is predicated on the determination that the limits to concurrent write operations enforced by file systems such that only one write operation may be performed at a time on a file is rooted in the desire to avoid two or more processes from changing the allocation of data blocks in the file and thereby corrupting the file structure. Other software mechanisms exist, such as in database applications, for ensuring consistency of the actual data written to the file data blocks, e.g., the two-phase commit. Therefore, the present invention seeks to remove the limitations of existing file systems with regard to write operations that do not change the allocation of data blocks in a file such that multiple concurrent write operations may be performed with the other software application integrity mechanisms governing how these changes to the file are to be implemented.

With the present invention, write operations that do not require or result in a change to the allocation of data blocks associated with a file may take a reader lock rather than the writer lock. As a result, multiple concurrent write operations may be performed by processes as long as those write operations do not change the allocation of the block of data. If, however, a write operation changes the allocation of a block of data, then the write operation must obtain the writer lock before the operation may be performed. Since only one process may obtain the writer lock at a time, this forces serialization of write operations that change the allocation of data blocks in a file. That is, each write operation that changes an allocation must wait unit the writer lock is released by a process that currently is changing the allocation of data blocks in the file before it can perform its operations. The present invention does not avoid or bypass the file locking, but makes use of the file locks to permit multiple concurrent readers and writers.

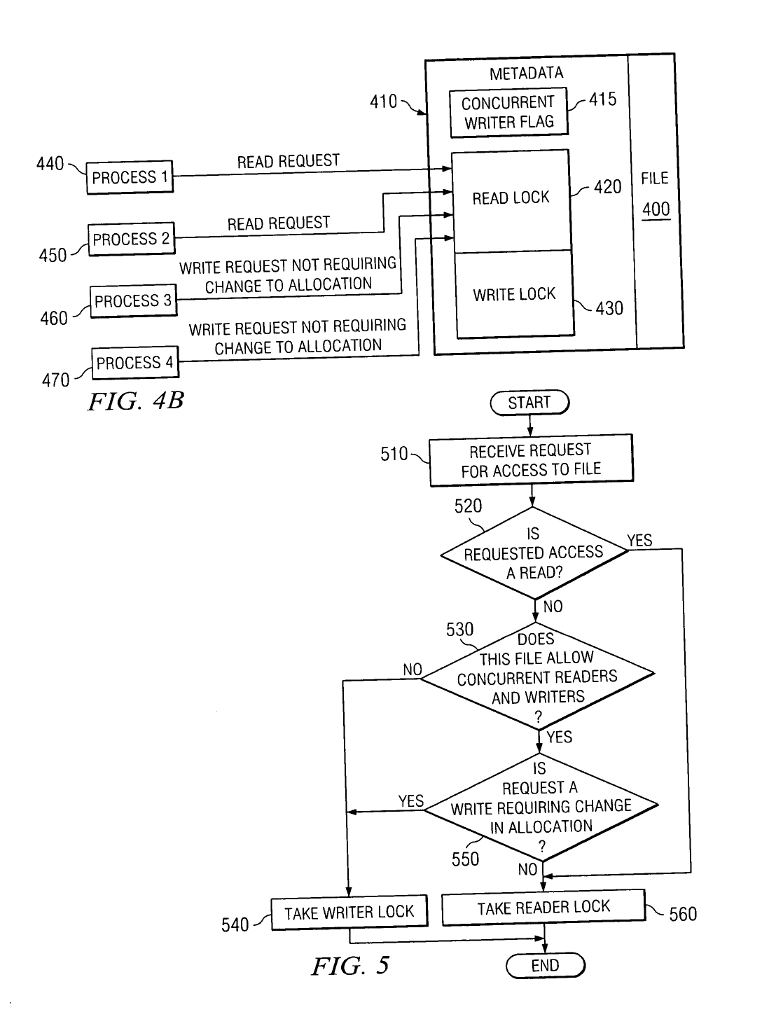

FIG. 4A is an exemplary diagram illustrating the acquiring of locks with regard to a write access request that requires a change in allocation of data blocks for a file in accordance with the present invention. As shown in FIG. 4A, a file 400 has associated metadata 410 that includes a concurrent writer flag 415, a read lock 420 and a write lock 430. The concurrent writer flag 415 may be set by an application that initially creates the file 400 to indicate whether that application permits concurrent writers to the file 400. With the present invention, only applications that have their own internal serialization or integrity management mechanisms may set the concurrent writer flag 415 such that the file 400 may be accessed by multiple concurrent writers, i.e. processes that are requesting write access to the file 400. An example of such an application is a database application which includes its own serialization mechanisms for serializing the concurrent writes to data blocks in order to maintain the integrity of the file structure.

In order for a process to access the file 400, the process must obtain a lock on the file 400. If the process wishes to read data from the file 400, the process may obtain a read lock 420 associated with the file 400. If the process wishes to write data to the file 400, the process may have to obtain either the read lock 420 or the write lock 430 depending on the type of write operation being performed.

If the write operation that is being performed by a process is one that requires or results in a change in the allocation of data blocks to the file 400, then the process requesting access to the file 400 must obtain the write lock 430. The access policy associated with the metadata precludes more than one process from acquiring the write lock 430 at any one time. Thus, if two processes are attempting to write the file 400, and both processes' write operations require or result in a change to the allocation of data blocks in the file 400, then only one of these processes will be allowed to proceed by obtaining the write lock 430 while the other must spin on the lock. It should also be noted that readers must also spin while the writer lock is taken and the write lock cannot be taken while there is a reader lock.

Thus, as shown in FIG. 4A, process 1 440 and process 2 450 send read access requests to the file system requesting access to the file 400 so that they may read data from the file 400. As a result, each of process 1 440 and process 2 450 obtain the read lock 420 associated with the file 400. Process 3 460, however, sends a write access request to the file system requesting access to the file 400 so that the process 460 may write data to the file 400. This writing of data is determined to require or result in a change in the allocation of data blocks within file 400.

As previously mentioned, one situation in which a write access request will change the allocation of the data blocks of the file is when a file is extended, i.e. the request is a request to write to an offset that is greater than the current file size. Another situation where a write access request will change the allocation of the data blocks is when the file is truncated. Both of these situations require an update to the metadata structure associated with the file.

Another situation that results in a change to the metadata structure of the file is when an input/output request on the file violates the alignment or length restrictions of direct input/output. That is, the use of concurrent input/output preferably makes certain alignment and length restrictions that are to be adhered to by the application's I/O requests. By creating file systems with an appropriate block size, e.g., by specifying an aggregate block size equal to 512 kb at file system creation, such applications can benefit from the use of concurrent I/O without any modifications to the applications.

As a result of determining that the Process 3 460 requires a change in the allocation data blocks within the file 400, the process 460 must obtain the write lock 430 in order to perform its write operations to data blocks of the file 400. If the process 460 is unable to acquire the write lock 430 immediately, the process 460 may spin on the write lock 430 until it is released by the process that currently has the write lock 430.

With the present invention, if the write operation of a process will not require or result in a change in the allocation of the data blocks in the file 400, then the process may obtain the read lock 420 rather than being forced to obtain the write lock 430. That is, the present invention differentiates between two different types of write accesses, a write that will change the allocation of data blocks in the file 400 and a write that will not change the allocation of data blocks in the file 400.

FIG. 4B is an exemplary diagram illustrating the acquiring of locks with regard to a write access request that does not change the allocation of data blocks for a file in accordance with the present invention. As illustrated in FIG. 4B, the processes 440 and 450 send read access requests to the file system requesting access to the file 400 to read data from the file 400. These processes acquire the read lock 420 and are able to concurrently perform read operations on the data in the file 400.

The processes 460 and 470 submit write access requests to the file system requesting access to the file 400 to write data to the file 400. The write operations that processes 460 and 470 are intending to perform are determined to be of a type that does not require or result in a change to the allocation of data blocks in file 400. Since the write operations do not change the allocation of data blocks in the file 400, the processes 460 and 470 are permitted to acquire the read lock 420 and thus, are able to concurrently write data to the file 400. Software based mechanisms, such as database application serialization mechanisms, are utilized to determine how the concurrent write operations are to be serialized such that file structure integrity is maintained.

Thus, the present invention provides a mechanism for eliminating the bottleneck to performance found in the access policy of conventional file systems with regard to permitting only a single writer to a file at any one time. With the present invention, this limitation is lifted with regard to write operations that do not require or result in a change in the allocation of data blocks in the file. As a result, multiple concurrent write operations may be performed without sacrificing the file structure integrity. Existing software based serialization and locking mechanisms associated with an application present on the computing system are utilized to govern how these concurrent write operations are to be reflected in the file structure such that the integrity of the file structure is maintained.

FIG. 5 is a flowchart outlining an exemplary operation of the present invention. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 5, the operation starts by receiving a request for access to a file (step 510). A determination is made as to whether this access request is a read access request (step 520). If so, the reader lock is taken (step 560). If the request is not a read request then it is determined that the request is a write access request.

If the access request is not a read access request, a determination is made as to whether the file to which access is requested allows concurrent readers and writers (step 530). As mentioned above, this may involve determining the value of a concurrent writer flag in the metadata of the file, for example. If the file does not permit concurrent writers, the writer lock is taken (step 540). This assumes that the writer lock is available and has not been acquired by another process. If the writer lock is already acquired by another process, the current process may spin on the lock until it is released so that the current process may acquire it. As mentioned above, only one process may acquire the writer lock at any one time and thus, no other processes that are attempting to perform a write to the file will be able to perform their operation until after the writer lock is released.

If the file does allow multiple concurrent writers, then a determination is made as to whether the write request is one that will require or result in a change in the allocation of data blocks in the file (step 550). If so, the writer lock is acquired (step 540) as discussed above. Otherwise, if the write request is one that will not require or result in a change in the allocation of data blocks in the file, then a reader lock may be acquired by the process submitting the write request (step 560). As previously mentioned, multiple processes may acquire the reader lock on the file and thereby access the file concurrently. With the present invention, since write requests that do not change the allocation of data blocks of a file may acquire this lock, multiple concurrent writers to the file are possible. The present invention allows the serialization mechanisms of the applications of the computing device, e.g., the database application, to govern how changes to the file are to be committed. Thus, the file system of the present invention only limits processes from writing to a file concurrently when the write operations would result in a change in the allocation of data blocks of the file.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of providing write access to a file, comprising:
receiving a write access request from a process for write access to the file;
determining if a write operation associated with the write access request results in a change to an allocation of data blocks in the file; and
permitting the process to obtain a read lock associated with the file to perform the write operation if the write operation does not result in a change to the allocation of data blocks in the file.

2. The method of claim 1, further comprising:
requiring that the process obtain a write lock associated with the file to perform the write operation if the write operation results in a change to the allocation of data blocks in the file.

3. The method of claim 1, wherein multiple processes may have concurrent access to the file by obtaining a read lock associated with the file.

4. The method of claim 2, wherein only one process may obtain the write lock at a time.

5. The method of claim 1, wherein the process performs the write operation to the file concurrently with another write operation to the file from another process.

6. The method of claim 1, wherein determining if the write operation results in a change to an allocation of data blocks in the file includes determining if the write operation is to an offset that is greater than a current file size.

7. The method of claim 1, wherein determining if the write operation results in a change to an allocation of data blocks in the file includes determining if the write operation is to truncate the file.

8. A computer program product in a computer readable medium for providing write access to a file, comprising:
first instructions for receiving a write access request from a process for write access to the file;
second instructions for determining if a write operation associated with the write access request results in a change to an allocation of data blocks in the file; and
third instructions for permitting the process to obtain a read lock associated with the file to perform the write operation if the write operation does not result in a change to the allocation of data blocks in the file.

9. The computer program product of claim 8, further comprising:
fourth instructions for requiring that the process obtain a write lock associated with the file to perform the write operation if the write operation results in a change to the allocation of data blocks in the file.

10. The computer program product of claim 8, wherein multiple processes may have concurrent access to the file by obtaining a read lock associated with the file.

11. The computer program product of claim 9, wherein only one process may obtain the write lock at a time.

12. The computer program product of claim 8, wherein the process performs the write operation to the file concurrently with another write operation to the file from another process.

13. The computer program product of claim 8, wherein the second instructions for determining if the write operation results in a change to an allocation of data blocks in the file include instructions for determining if the write operation is to an offset that is greater than a current file size.

14. The computer program product of claim 8, wherein the second instructions for determining if the write operation results in a change to an allocation of data blocks in the file include instructions for determining if the write operation is to truncate the file.

15. An apparatus for providing write access to a file, comprising:
means for receiving a write access request from a process for write access to the file;
means for determining if a write operation associated with the write access request results in a change to an allocation of data blocks in the file; and
means for permitting the process to obtain a read lock associated with the file to perform the write operation if the write operation does not result in a change to the allocation of data blocks in the file.

16. The apparatus of claim 15, further comprising:
means for requiring that the process obtain a write lock associated with the file to perform the write operation if the write operation results in a change to the allocation of data blocks in the file.

17. The apparatus of claim 15, wherein multiple processes may have concurrent access to the file by obtaining a read lock associated with the file.

18. The apparatus of claim 16, wherein only one process may obtain the write lock at a time.

19. The apparatus of claim 15, wherein the process performs the write operation to the file concurrently with another write operation to the file from another process.

20. The apparatus of claim 15, wherein the means for determining if the write operation results in a change to an allocation of data blocks in the file includes means for determining if the write operation is to an offset that is greater than a current file size.

21. The apparatus of claim 15, wherein the means for determining if the write operation results in a change to an allocation of data blocks in the file includes means for determining if the write operation is to truncate the file.
